(19) United States
(12) Patent Application Publication
(10) Pub. No.: US 2017/0061741 A1
(43) Pub. Date: Mar. 2, 2017

(54) GAMING DEVICE AND METHOD FOR AN ELECTRONIC MULTI-DEALER VIDEO POKER

(71) Applicant: Vladimir Dunaevsky, Toronto (CA)

(72) Inventor: Vladimir Dunaevsky, Toronto (CA)

(21) Appl. No.: 15/056,991

(22) Filed: Feb. 29, 2016

Related U.S. Application Data
(60) Provisional application No. 62/210,435, filed on Aug. 26, 2015.

(51) Int. Cl. G07F 17/32

(52) U.S. Cl. CPC G07F 17/3293; G07F 17/326; G07F 17/3225

(57) ABSTRACT

Embodiments of the present invention comprise a poker gaming system and method in which a player can play with one or more hands against multiple dealers for games involving community cards. Community cards may be used by only the player when the player has multiple hands, or by both the player and the dealer. Player hand(s) are compared against each dealer's hand to determine the game results. Players may place initial bets on the likelihood that their hand(s) are better than each of the dealer's hands. After players place bets, their cards and the community cards are withdrawn from the plurality of decks in duplicate manner. Each of the dealer's hands are independently withdrawn from each decks. The player's hand(s) is/are compared to each of the dealer's hands using various conventional rules of poker, and payouts are determined.

### RELATED APPLICATION

This application claims priority to U.S. Patent Application Ser. No. 62/210,435, filed on Aug. 26, 2015, the content of which is incorporated herein in its entirety.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the file or records of the patent office of any jurisdiction, but otherwise reserves all copyright rights whatsoever.

### BACKGROUND

Field of the Invention

This invention relates primarily to electronic video poker with community card(s) that allows the player(s) to play with one or more hands against multiple dealer's hands rapidly.

Background of the Art

Gambling is a fundamental human activity. In the early history of man, prehistoric existence was a struggle of gamblers against nature with the ultimate prize of survival. Today, with daily routines, man's necessity to gamble is getting involved in the action of everyday living. It is a feeling of adventure that seeks changes, a search for the unknown and a fascination with games of chance. Any video poker player knows that the more hands you play, the greater the chance of winning, and any casino operator knows that the more hands played, the more revenue there is to be generated, since the house always has the edge.

Poker games that feature the use of community cards are often referred to as community card games. The community cards are dealt in the center of the table and can be used by multiple players and dealer to make up a poker hand. The most popular community card game to be widely played in recent years is Texas Holdem poker. At the end of a game, each player and dealer has two cards in his possession and has access to five community cards from which he can make up a winning poker hand. Sometimes, community card games will restrict players to including a specific number of community cards in their poker hands. For example, players in Omaha Hold'em must use three of the five community cards dealt and exactly two of the four cards they receive from the dealer to make a hand.

In recent years community cards poker has become popular in land base and online casinos where players are playing against the house (also referred to as the dealer) in traditional table game play manner. It is a mainstay at all types of casinos all over the United States and the world.

Computer base (electronic table) casino type poker is played with a single dealer on stand-alone gaming devices or on client devices, such as computers or the like, which communicate with servers over a network, such as the Internet.

Typically, with electronic community cards poker, one or more computers control the dealing of the cards from a virtual deck or shoe. Video poker permits a player to play one or more hands against a single dealer hand. Each player hand gives only one result per round of game, which limits the game provider to increase profits in any given period of time.

This invention relates primarily to electronic video poker games, and more particularly to community cards poker games that are based on the comparison of player hand(s) versus multiple-dealers hands. It includes multi-hand video poker game variations (numerous patents assigned to IGT, Inc.), Texas Hold'em poker (patent assigned to Shuffle Master, Inc.), Three Card Multi-Hand Video Poker (application assigned to Rational Intellectual Holdings Limited) and Multi-Hand Video Blackjack (application assigned to Cryptologic, Inc.). These games optimize speed; maintain player interest by providing a wide range of game play. However, such games are not community card type games wherein community cards are withdrawn from multiple shoes for either the player or player and dealer to allow the player to play multiple hands against multiple-dealers simultaneously.

U.S. Pat. No. 8,408,983 B2 (Dunaevsky et al.), describes an electronic blackjack card game where a player plays one or more hands against multiple dealer hands. The game incorporates traditional blackjack rules. For example, in Multi-Hand Video Blackjack, players can add to their speed and excitement by playing five hands at once against up to 50 dealer hands, meaning player has the chance to beat the dealer up to 250 times in one round.

U.S. Pat. No. 9,105,158 B2 (Moody), describes a variant of electronic multi-hand video poker game in which the player plays multiple hands of cards. The game deals from one deck to a main hand and players select cards to hold in the main hand and all the active hands on the screen. On the draw, the player is dealt cards from up to 100 different decks.

Roger Snow U.S. Pat. No. 6,986,514 B2 (assigned to Shuffle Master, Inc.), describes the basic play of a Texas Hold'em poker casino table game played against multiple dealer hands.

U.S. patent application Ser. No. 2015/0221185 A1 (Dunaevsky et al.) describes a poker gaming system in which a user can select a number of user hands and a number of dealer hands to play against.

### SUMMARY OF THE INVENTION

The present invention applies to Community Card Poker games (with different kinds of variants) with the common thread being the approach taken to represent (1) player card(s), (2) community card(s) and (3) dealer cards. Identical player and community cards are withdrawn from multiple virtual decks. Each identical player or community card withdrawn from multiple decks is represented as one virtual card. However, dealer's cards are withdrawn independently from each corresponding deck. Every dealer withdrawn card is unique and appears on the display. This invention involves features which may apply to casino electronic gambling equipment such as bet and card detection equipment, electronic casino tables and computer base internet gaming.

According to the first aspect of the invention, it is a method for playing an electronic multi-dealer video poker game. The method comprises:
a) virtual table having at least one player, at least one hand per player, community card(s) and a plurality of dealer hands;
b) player cards dealt from a primary virtual deck of cards;
c) community cards for use by either only the player or both player and dealers, dealt from a primary virtual deck of cards either face up or face down as defined by conventional poker game rules and player input;
d) discard from the plurality of secondary virtual decks, cards that have been already withdrawn from the primary virtual deck for use by the player or group of community card(s);
e) independently deal random cards to each dealer hands (cards face down) from all virtual decks (including primary and all secondary virtual decks);
f) reveal all at once or in stages, community cards and evaluate player hand(s);
g) reveal and evaluate dealer hands;
h) compare player(s) hand(s) with dealer's hands to determine a plurality of game results (win, lose or push) as defined by conventional poker hand ranks.

According to the second aspect of the invention, it is a server for an electronic multi-dealer video poker game device. The server comprises:
a) communicating with the client devices to render a virtual table having at least one player, at least one hand per player, community card(s) and a plurality of dealer hands;
b) deal player cards dealt from a primary virtual deck of cards;
c) deal community cards for use by either only the player or both player and dealers, dealt from a primary virtual deck of cards either face up or face down;
d) discard from the plurality of secondary virtual decks, cards that have been already withdrawn from the primary virtual deck for use by the player or group of community card(s);
e) independently deal random cards to each dealer hands (cards face down) from all virtual decks (including primary and all secondary virtual decks);
f) reveal all at once or in stages, community cards and evaluate player hand(s);
g) reveal and evaluate dealer hands;
h) compare via the electronic processing device, player(s) hand(s) with dealer's hands to determine a plurality of game results (win, lose or push).

According to the third aspect of the invention, it is a device for enabling a player to play an electronic multi-dealer video poker game. The client device comprises:
a) input devices;
b) output devices; and
c) a microprocessor operable with input and output devices to:
   communicate with server to render a virtual table having at least one player, at least one hand per player, community card(s) and a plurality of dealer hands;
   ii. deal player cards dealt from a primary virtual deck of cards;
   iii. deal community cards for use by either only the player or both player and dealers, dealt from a primary virtual deck of cards either face up or face down;
   iv. discard from the plurality of secondary virtual decks, cards that have been already withdrawn from the primary virtual deck for use by the player or group of community card(s);
   v. independently deal random cards to each dealer hands (cards face down) from all virtual decks (including primary and all secondary virtual decks);
   vi. reveal all at once or in stages community cards, and evaluate via server player hand(s);
   vii. reveal and evaluate via server dealer hands;
   viii. compare via server, player(s) hand(s) with dealer's hands to determine a plurality of game results (win, lose or push).

According to the fourth aspect of the invention, it is a system for enabling a player to play electronic multi-dealer video poker game. The system comprises:
a) a server;
b) a client device adapted for communication with the server via a network; and
c) the server operable with the client device to:
   i. render a virtual table having at least one player, at least one hand per player, community card(s) and a plurality of dealer hands;
   ii. deal player cards dealt from a primary virtual deck of cards;
   iii. deal community cards for use by either only the player or both player and dealers, dealt from a primary virtual deck of cards either face up or face down;
   iv. discard from the plurality of secondary virtual decks, cards that have been already withdrawn from the primary virtual deck for use by the player or group of community card(s);
   v. independently deal random cards to each dealer hands (cards face down) from all virtual decks (including primary and all secondary virtual decks);
   vi. reveal all at once or in stages community cards, and evaluate player hand(s);
   vii. reveal and evaluate dealer hands;
   viii. compare player(s) hand(s) with dealer's hands to determine a plurality of game results (win, lose or push) that are displayed to the player.

### BRIEF DESCRIPTION OF THE DRAWINGS

FIG. 1 is a block diagram of a multi-hand video poker system according to an embodiment of the present invention.

FIG. 2 is a block diagram of a gaming suite and a gaming database according to an embodiment of the present invention.

FIG. 3 is a flowchart of the gameplay process for a multi-hand video poker game according to an embodiment of the present invention.

FIGS. 4(A)-(B) are examples of User Interfaces (UIs) for a poker game according to an embodiment of the present invention.

FIG. 5 is an example of a UI for a poker game according to an embodiment of the present invention.

FIGS. 6(A)-(E) are examples of UIs for a poker game according to an embodiment of the present invention.

FIGS. 7(A)-(E) are examples of UIs for a poker game according to an embodiment of the present invention.

FIG. 8 is an example of a UI for a poker game according to an embodiment of the present invention.

FIG. 9 illustrates a gaming device according to an embodiment of the present

FIG. 10 illustrates an electronic gaming table device according to an embodiment of the present invention.

FIGS. 11(A)-(C) are exemplary pay-out tables for the various types of bets made in a multi-hand poker game according to an embodiment of the present invention

### DETAILED DESCRIPTION

Embodiments of the present invention comprise a community cards poker gaming system in which a user may select the number of user hands and the number of dealer hands to play against. Cards are dealt to the user, the community group, and the dealer. The user may place an initial bet based on his hand(s) and the likelihood that his best hand(s) are better than each of the dealer's best hands. Either the user only, or both the user and dealer may form their best hands using their individual cards and community card(s), as defined by conventional poker rules. The user may also have the option to place side bets in which the user may receive bonuses based on his hand(s) alone, independent of the dealer's hand(s). After the user places his bets, the user's initial cards are revealed. The user's hand(s) are compared to each of the dealer's hands, and payouts are determined.

Embodiments of the present invention comprise of a poker gaming system in which a user can select the number of dealers to play against. The game play may follow a variety of casino style, community card poker game rules. It may apply to multi-dealer against multi-player or multi-dealer against single-player format. According to community card poker game rules, cards are dealt first to the user, secondly to designated placeholders for community card(s), and finally to the multiple dealers.

The presented invention involves withdrawing community card(s) from all decks simultaneously, and all those cards are represented by a single set of community card(s).

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems, devices and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, smartphone and smartwatch. Program code is applied to input data to perform the functions described herein and generate output information. The output information is applied to one or more output devices, in known fashion.

Each program is preferably implemented in a high level procedural, functional or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. Read Only Memory (ROM) or Solid State Drive (SSD)) readable by a general or special purpose programmable computer, for configuring and operating the computer when the storage media or device is read by the computer to perform the procedures described herein. The inventive methods may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more wireline transmissions, satellite transmissions, internet transmission, electronic storage media, digital and analog signals, and the like. The computer useable instructions may also be in various forms, including compiled and non-compiled code.

Described herein are various embodiments of a gaming device and method for playing a multi-hand electronic poker game (sometimes referred to herein as “the game” for conciseness).

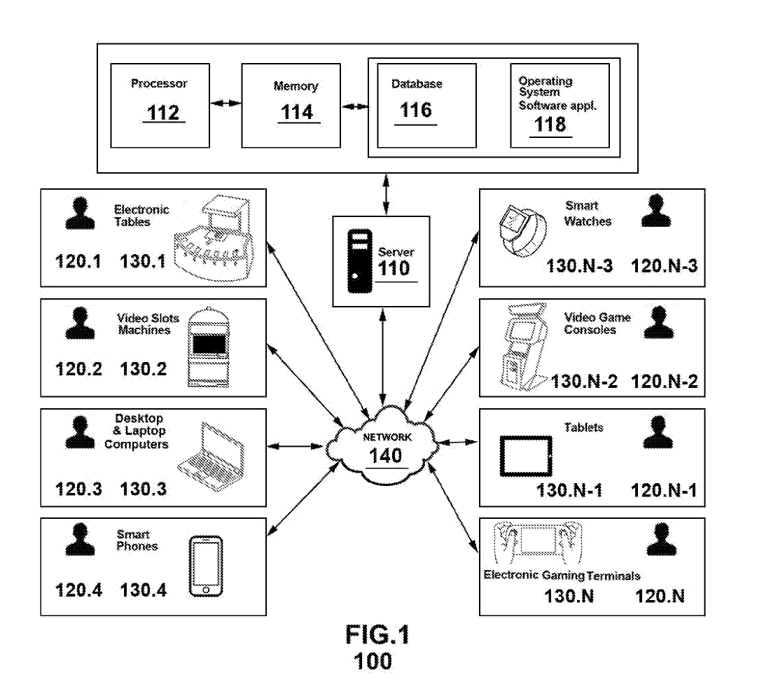

FIG. 1 is a block diagram of a multi-hand video poker system 100 according to an embodiment of the present invention. The system 100 may include a server 110, a network 140, and a plurality of users (or players) 120.1-120.N and associated devices 130.1-130.N.

The network 140 may include any number of Local Area Networks (LANs), Wireless Local Area Networks (WLANs), Wide Area Networks (WANs), mobile communication networks, and the Internet to facilitate communication between the server 110 and the user devices 130.1-130.N.

The devices 130.1-130.N may include, but are not limited to electronic tables (130.1 for example), video slot machines (130.2 for example), desktop & laptop computers (130.3 for example), smartphones (130.4 for example), video game terminals, tablets, video game consoles, smartwatches (130.N-130.N−3) for example, and other devices that may be capable of accessing a website or application over the network 140 to allow the users 120.1-120.N to participate in video poker games hosted by the server 110. For example, a given user (120.3) may operate an electronic table desktop base (130.3) or user (120.N−1) may operate tablet computer (130.N−1) to navigate to the video poker website by using a web browser. Some users (120.4 or 120.N) may download and access a mobile application to access the video poker content on their mobile tablet (130.N−1) or smartphones (130.4), Video Game consoles (130.N−2) and smartwatches (130.N−3).

The sever 110 may include various sub-components such as a processor 112 and a memory 114. The processor 112 may be provided in various configurations, such as a Central Processing Unit (CPU), a Field-Programmable Gate Array (FPGA), an Application Specific Integrated Circuit (ASIC), or any other suitable logic device or combination of logic devices. The processor 112 may execute video poker programs and access/modify data associated with such programs as described below.

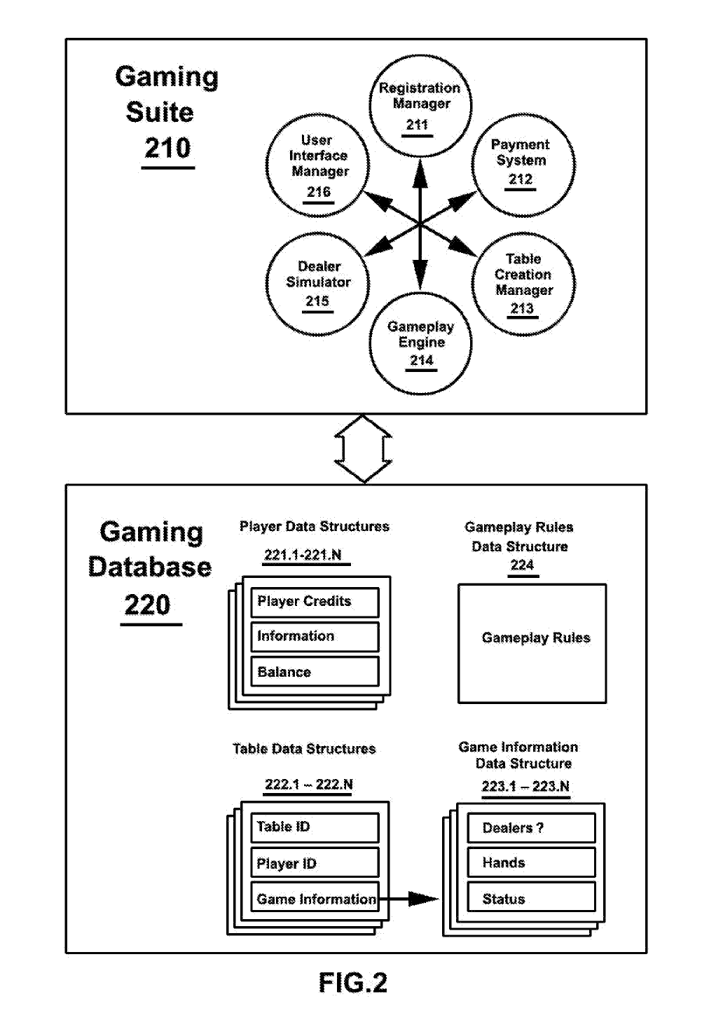

The memory 114 may include a machine readable medium which may include volatile memory (such as DRAM, SRAM, or the like) and non-volatile memory (such as ROM, FLASH, E²PROM, or the like). The memory 114 may store processor-executable instructions 118 (i.e., software programs such as operating system software and other software applications that may be used to run the video poker website or application) and a database 116 which may be modified and/or accessed by the processor 112. The software applications 118 may include a suite of gaming programs (or software applications described in further detail below with respect to FIG. 2) that may be used to run the community cards video poker game website and/or application. There may be other types of software applications stored in the memory as desired by the server administrators. The database 116 may be a hierarchical database that may include linked data structures (described in more detail with respect to FIG. 2) that store information. The information may include player information, game rules, game information, etc.

The server 110 and the devices 130.1-130.N may include communication interfaces to enable them communicate with each other over the network 140. As described in more detail below, the server 110 may host community cards video poker games that may be accessed by the devices 130.1-130.N to allow players to play the games according to an embodiment of the present invention.

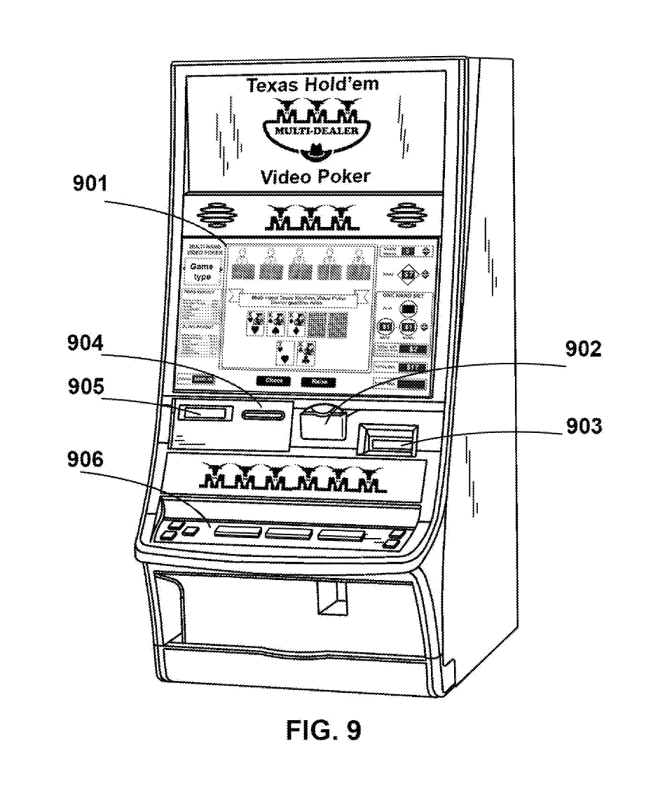

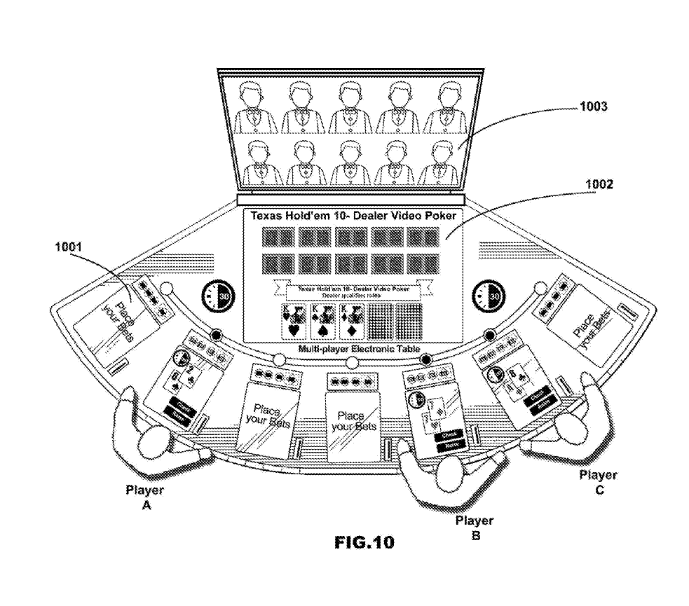

According to an embodiment of the present invention, the video game terminal 130.N (or any of the other devices 130.1-130.N−3 discussed above) may include an internal processor 112 and memory 114 and may locally host community card poker games. In such an embodiment, the video game terminal 130.N-130.N−3 may not need to connect to the server 110 to allow a user to play video poker. Instead, the memory 114 of the terminal 130.N may include the database 116 and the operating system/software applications 118 described above. Such a device 130.N may be located in a live casino floor as a video terminal or kiosk, a hotel operating on a local network, cruise ships, and airplanes for on-flight gaming networks, for example. FIGS. 9-10 are examples of such video gaming terminals.

FIG. 2 is a block diagram of a gaming suite 210 and a gaming database 220, which may be stored in the memory 114 of the gaming system 100 of FIG. 1. The gaming database 220 may include a plurality of player data structures 221.1-221.N, a plurality of virtual poker table data structures 222.1-222.N, and a game rules data structure 224.

The player data structures 221.1-221.N may store information relating to each player (or user) that is registered to play video poker on a website or application hosted by the server 110. The player data may include: a player ID, log in credentials, preferences, payment information, current balance, etc.

The table data structures 222.1-222.N may store information relating to each active table on a website or application hosted by the server 110. The table data may include: a table ID, a player ID associated with the table, and corresponding game information 223.1-223.N. The game information data structures 223.1-223.N may include, for each corresponding table 222.1-222.N, the number of active virtual shoes or dealers on the table, the player's hand, the dealer hands, the game status, etc. The player data structures 221.1-221.N and the table data structures 222.1-222.N may be linked and may share common information.

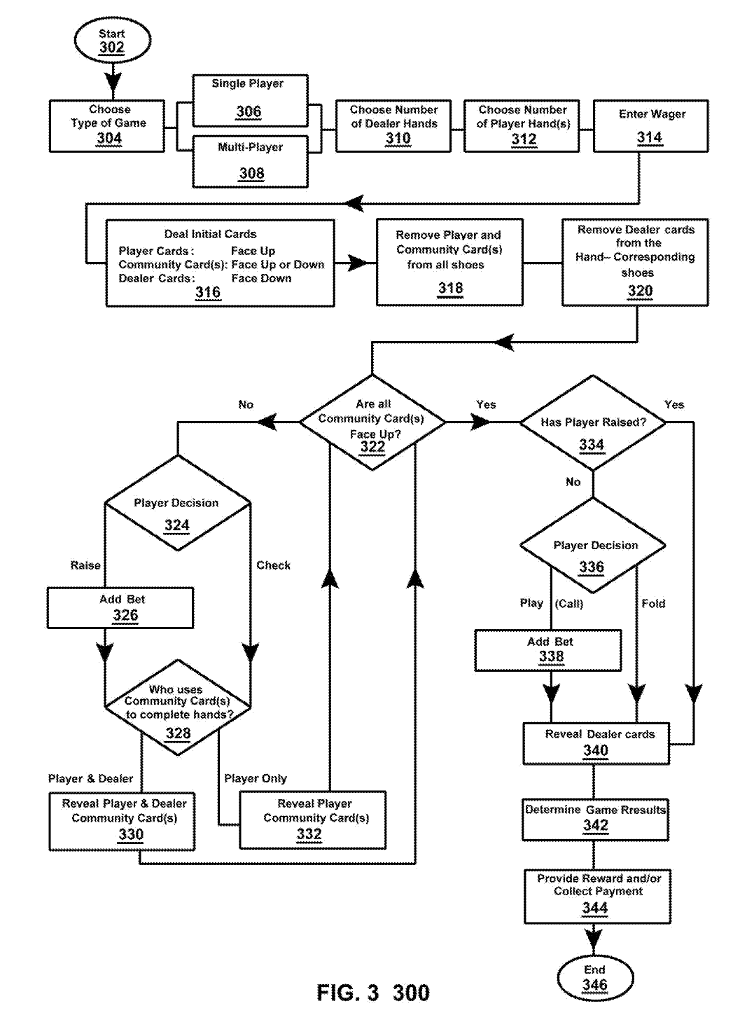

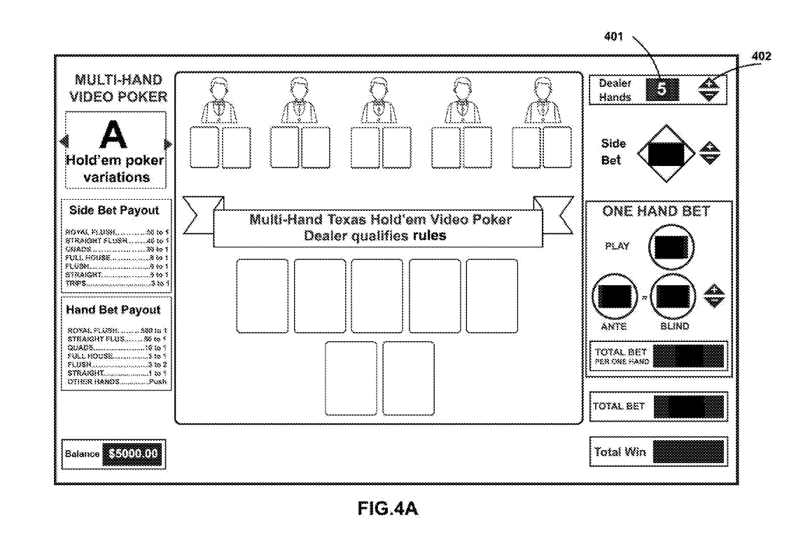

The game rules data structure 224 may include the rules of various poker games, including multi-hand Hold'em video poker (described below with respect to FIGS. 3-10). The rules data structure 224 may also include statistics data associated with the various poker games and payout rules.

The gaming suite 210 may include a plurality of programs (or software applications) that may be stored in the memory 114 and executed by the processor 112 of FIG. 1. The programs may work together to operate the video poker games described below with respect to FIGS. 3-10. The programs may include at least a registration manager 211, a payment system 212, a table creation manager 213, a gameplay engine 214, a dealer simulator 215, and a User Interface (UI) manager 216.

The registration manager 211 may control the registration process for the community cards video poker website (or application) hosted on the server 110 of FIG. 1. Users may interact with the registration manager 211 to sign up for a game account. The registration manager 211 may access and modify data stored in the player data structures 221.1-221.N.

The payment system 212 may control the payment processing for the players. Users may be able to add money to their account or cash out their balance using the payment system 212. The payment system 212 may access and modify the player data structures 221.1-221.N, the table data structures 222.1-222.N, and the game information data structure 223.1-223.N associated with each unique table data structure 222.1-222.N.

The table creation manager 213 may create new table entries in the table data structures 222.1-222.N in response to a player's request to start a new game. The table creation manager 213 may access and modify the player data structures 221.1-221.N, the table data structures 222.1-222.N, and the game information data structures 223.1-223.N associated with each unique table data structure 222.1-222.N.

The gameplay engine 214 may control the gameplay aspects of the video poker website (or application) as described in more detail below with respect to FIG. 3-13. The gameplay engine 214 may access and modify data stored in the table data structures 222.1-222.N, the game information data structures 223.1-223.N associated with each unique table data structure 222.1-222.N, and the gameplay rules data structure 224.

The dealer simulator 215 may control the dealing, shuffling, and other features of each poker game table in response to a player's actions. The dealer simulator 215 may access and modify the table data structures 222.1-222.N, the game information data structures 223.1-223.N, and the gameplay rules data structure 224.

The UI manager 216 may control the visual design of the video poker website or application hosted on the server 110 of FIG. 1 and how the website or application interacts with users. For example, the UI manager 216 may determine where certain UI elements, such as logos, scroll bars, buttons, etc. are located on the website and/or application. The UI preferences may be selected by a system administrator.

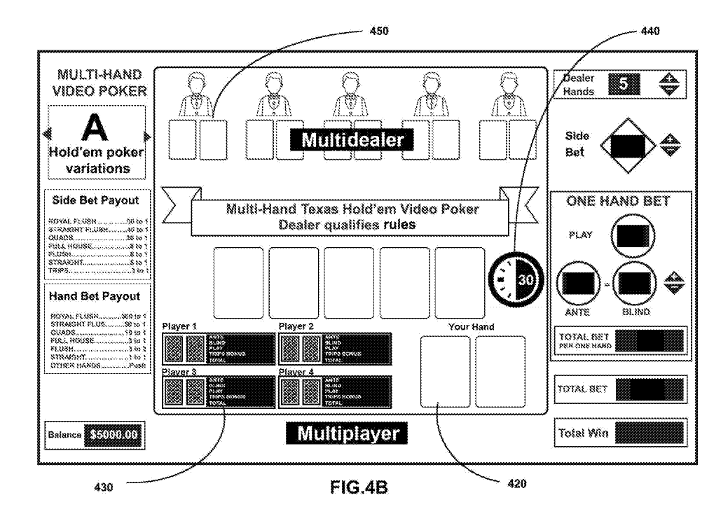

FIG. 3 is a flowchart 300 of the gameplay process for a multi-hand community cards video poker game according to an embodiment of the present invention. FIGS. 4-8 are screenshots of exemplary user interfaces (UIs) of a multi-hand video poker game generated by the UI manager 216 of FIG. 2. The screenshots in FIGS. 4-8 may correlate to the process described in the flowchart 300 illustrated in FIG. 3 as described herein below. Moreover, elements in the gaming suite 210 and gaming database 220 of FIG. 2 described above may be referenced in the description of FIGS. 3-8 below.

Once a player decides to play the multi-hand community cards video poker game, the table creation manager 213 may create a unique table data structure, 222.N for example, which may store information for the current game session as described above with respect to FIG. 2. The UI manager 216 may subsequently launch a user interface to allow the player to play multi-hand community cards video poker.

The method shown in FIG. 3 begins at step 302. At step 304, once the UI manager 216 launches the poker game user interface, the player may choose the type of game he/she wants to play. For example, the player may select a single player game (step 306) or a multi-player game (step 308).

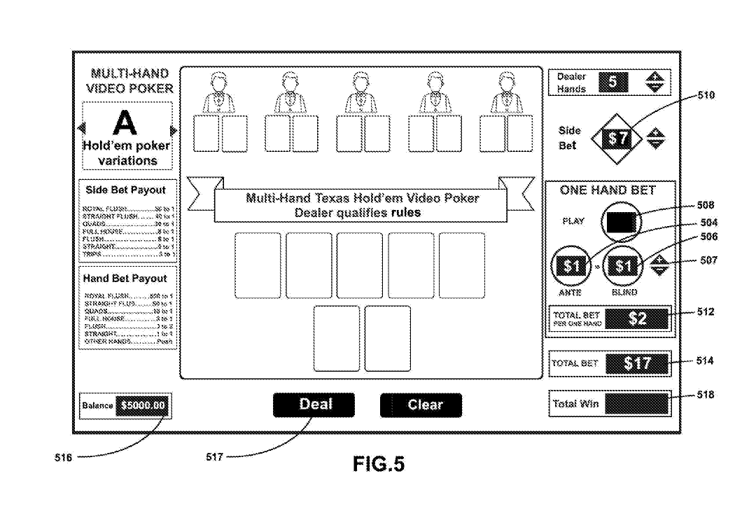

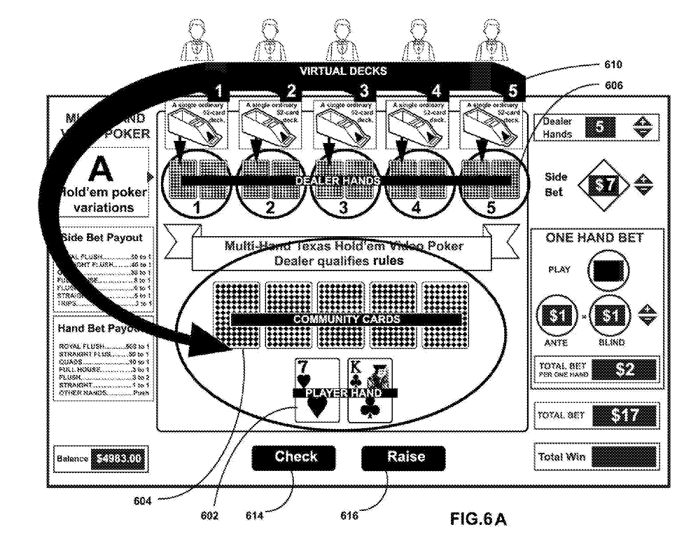

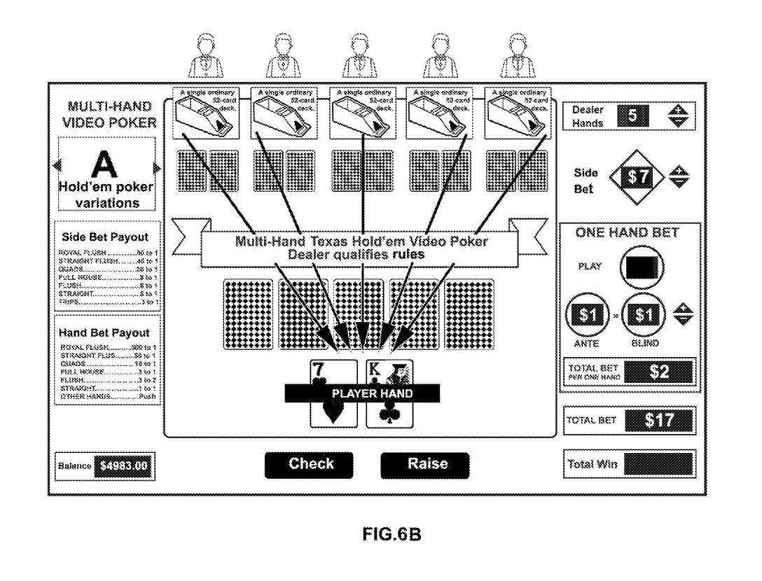

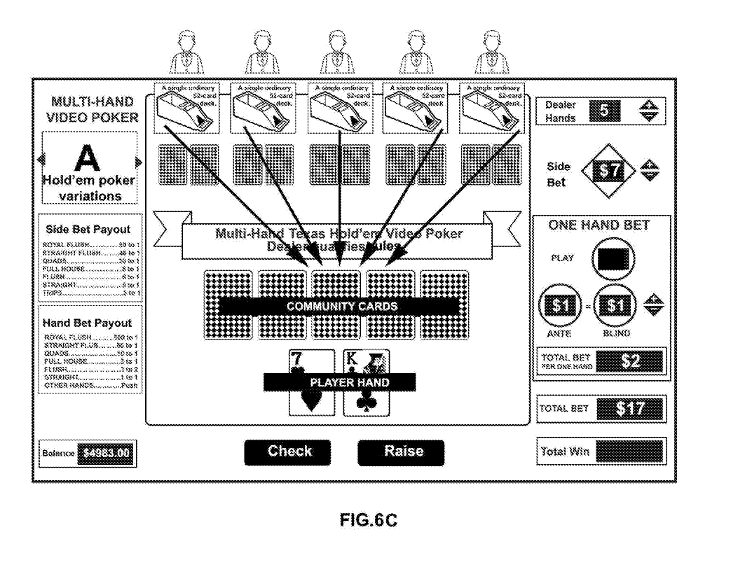

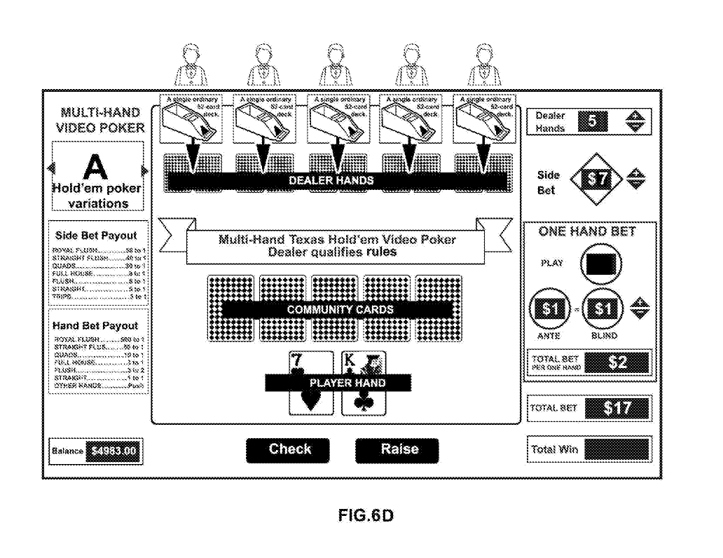

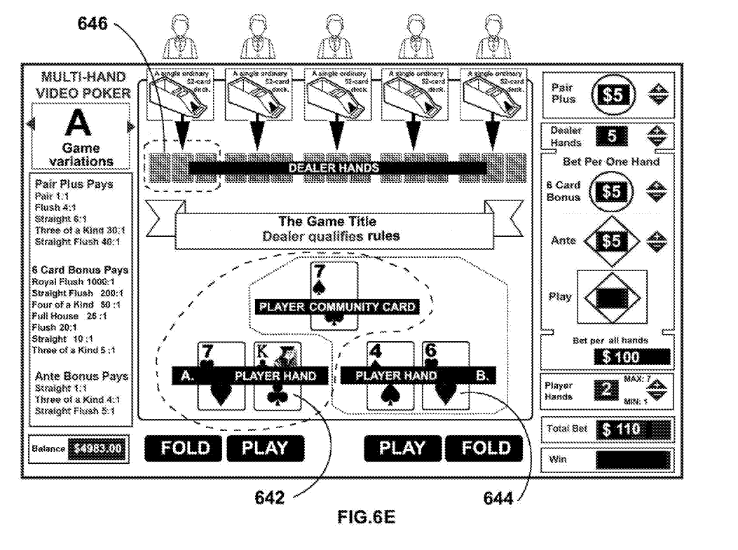

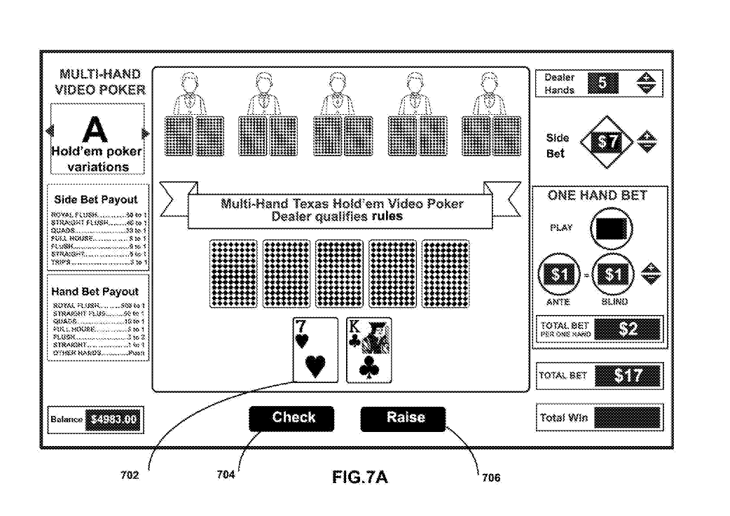

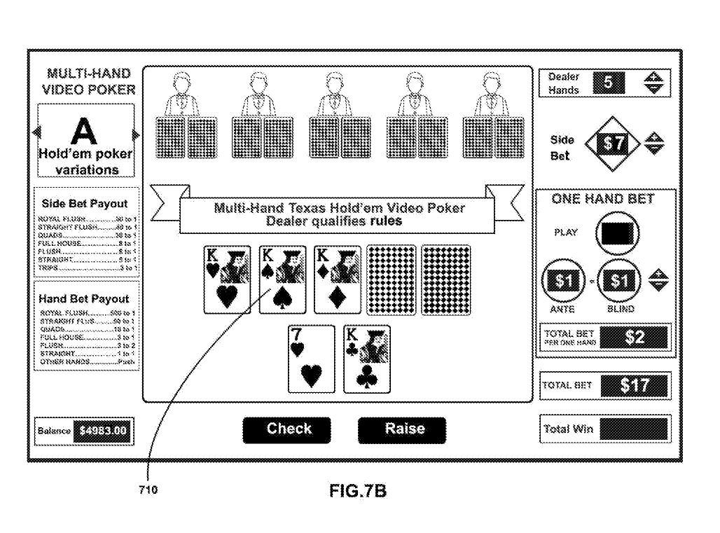

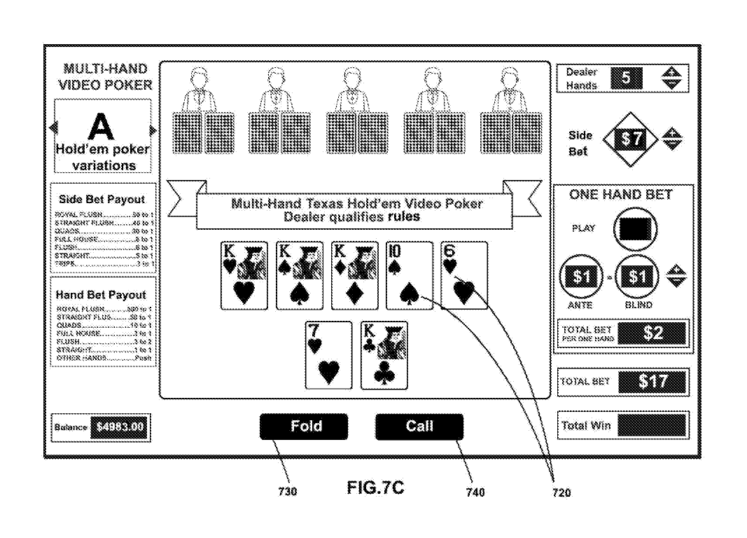

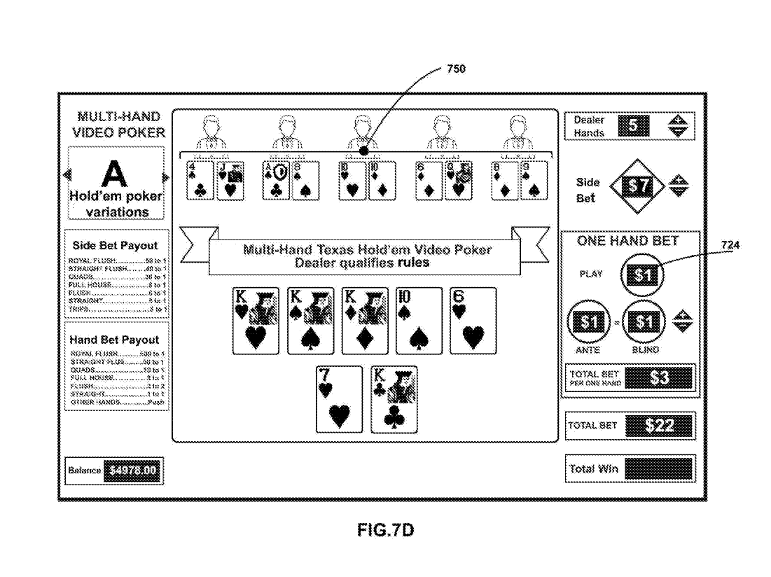

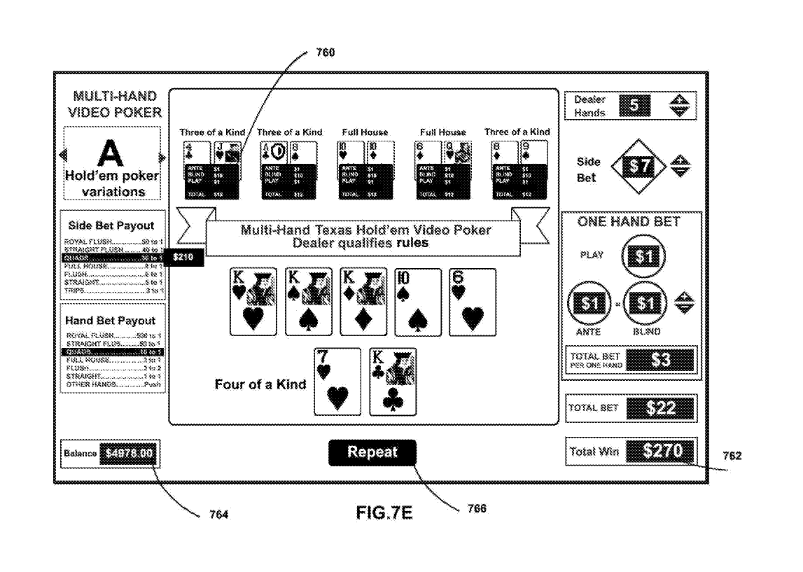

Next, the player may choose the number of dealers or dealer hands he/she would like to play against (step 310) and the number of hands he/she would like to play (step 312). These player's selections in steps 302-312 may be stored in the corresponding table data structure 222.N. Dealer avatars may be shown (FIG. 4. (A-B)) or may not be shown (FIG. 5) on the UI. Similarly, shoes may be shown (FIG. 6(A-E)) or not shown (FIG. 7(A-E)) on the UI.

FIG. 4(A) is an example a UI for a single player playing one hand against five dealers, each having one hand for a poker game according to an embodiment of the present invention. Sometimes herein for example, “five dealers, each having one hand” may be referred to as “five dealer hands” for conciseness. The UI may display this information in field 401. The UI may also include corresponding (+/−) controls, field 402 for the number of dealer hands. A player may directly enter a number into the fields 401 (e.g., using a keyboard) or use the (+/−) controls 402 to increase or decrease the number of player or dealer hands (e.g., using a mouse). In this example, the player may play only one hand against five dealer hands. In field 401, a corresponding number five represents five virtual dealers, each having one virtual shoe, with one deck of 52 standard cards. This information may be created and stored in a table data structure shown in field 222.N as described above with respect to FIG. 2.

FIG. 4(B) is an example of a multi-player UI where each player has one-hand. The UI may be similar to the UIs shown in FIG. 4(A); however, in this case, the user may choose to play with a group of other players against multiple dealers. Alternatively, the user may choose to play against other players in a tournament competition. As shown in FIG. 4(B), the UI may display the player's hand 420, other players' hands 430, and the multiple dealer hands 450. The UI may optionally include a timer 440 in the multi-player mode, which may govern the time limit to place initial bets for each player and the time limit to make a decision to play or to fold for each player. A player may have an option to pick the time limit for a given game. For example, there may be Fast-Play tables with 30-second timers or Slow-Play tables with 60-second timers.

At step 314, the player may place his/her initial bet per one hand. The initial bet may include mandatory bets (e.g., Ante bet is equal to Blind bet) and an optional side bet. The initial bet may be increased before the dealer's cards are revealed (step 340), at steps 326 and 338. As an example, the total wager is determined by adding Ante and Blind bets and then multiplying the result by the number of dealer hands.

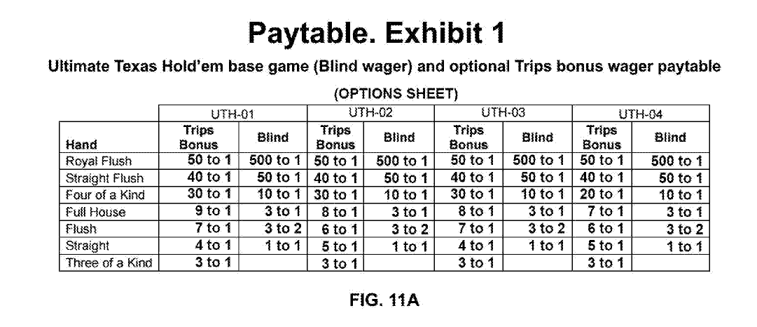

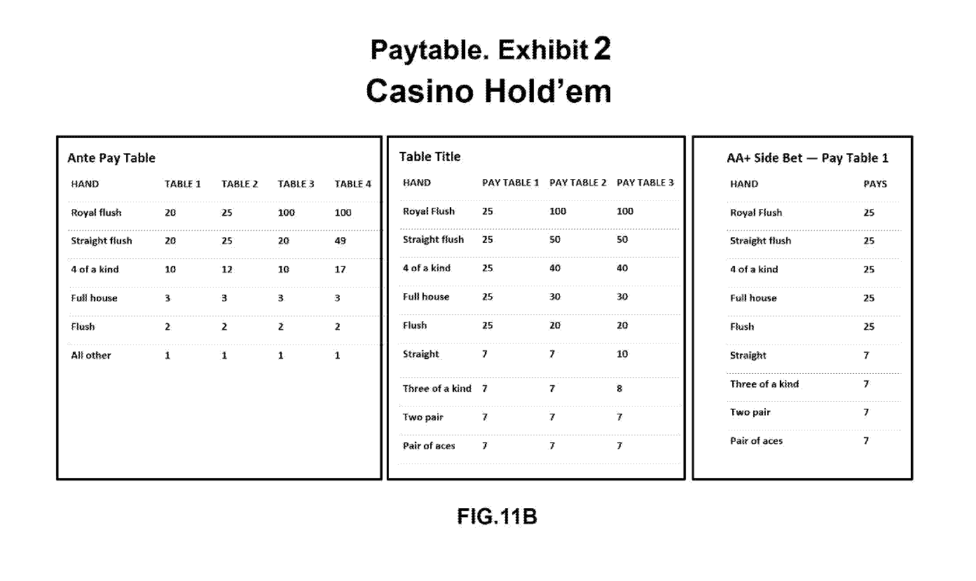

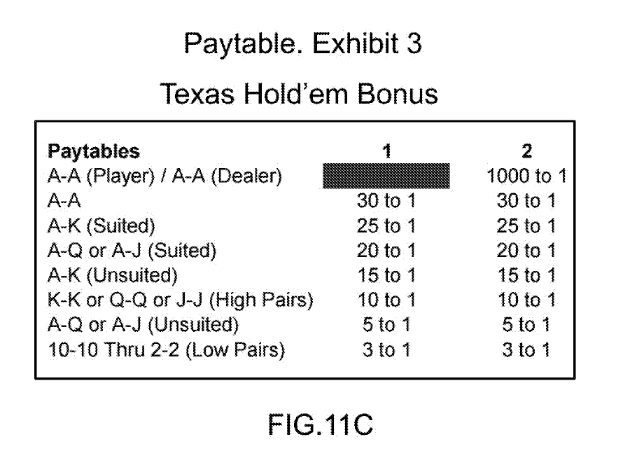

There may be one or more optional side bets. The side bet payout value is based on the best card combination comprising of the player's hand(s) and community cards (shown in FIGS. 11(A)-(C)).

FIG. 5 illustrates an example of a UI which includes an Ante bet-field 504, a Blind bet-field 506, a side bet at field 510, and corresponding (+/−) controls to increase or decrease bet per hand at field 507. In this example, the user selected Ante=Blind bet $1 per hand ($1 Ante bet+$1 Blind bet=$2 Total bet per hand) and Side bet of $7. At this stage of the game the player does not need to place any bet value on Play (field 508). Play bet needs to be placed at step 338.

In FIG. 5 example, the total bet per one individual hand of $2 may be displayed at field 512. The total bet per all hands may be displayed in the Total Bet field 512. This field does not include the Side Bet value (field 510). The overall Total Bet (field 514) includes Ante, Blind and Side Bets. In this example, the Total Bet is $17: ($1 Ante per hand+$1 Blind per hand)×5 dealer hands+$7 Side Bet. A Balance field 516, which indicates a player's current balance, gets adjusted according to the total bet value (field 514). When the player presses Deal (field 517), the player's balance is adjusted from $5,000 to $5000.00-$17.00=$4983.00. The player's balance value may be saved in a corresponding player data structure, say 221.N, may be updated accordingly. The UI manager shown in 216 is used to display the results of the bet input values after the player presses the Deal button 517.

At step 316, after the player presses Deal, the initial cards are dealt. At the end of step 316, player cards are always shown face up, community cards may be shown face up or down, and dealer cards are always shown face down. Player, community and dealer cards are dealt in a manner that allows for multi-dealer and/or multi-player hands to be played. For example, FIG. 6(A) shows that after step 316, two player cards are dealt face up, five community cards are dealt face down, and five dealer hands with two cards each are dealt face down.

At steps 318, player cards (field 602) and community cards (field 604) are removed from all virtual decks (field 610). This approach is taken for both single player and multiplayer games. Each virtual deck contains a single deck of standard fifty-two cards. The deck data corresponding for each virtual deck stored at a table data structure 222.N may be updated accordingly when player and community cards are dealt.

For example, in FIG. 6B the same two cards that are dealt to the player are removed from all five virtual shoes in single player mode. In case of a multi-player mode FIG. 4B, each player gets two random cards, that are different from other player's cards. All player cards are withdrawn from all virtual shoes. When a player receives their cards, other players may see this player's cards or may not, depending on the game view mode—either Public View or Private View. The setting for view mode may affect which game strategy is used and which payout tables are used.

FIG. 6C illustrates a dealing of five community cards face down. Just like for player cards, identical community cards are removed from all virtual shoes.

At step 320, dealer cards are dealt at random from each shoe. This occurs only after player and community cards have been withdrawn. This process is the same for single and multi-player modes. For example, in single player mode, FIGS. 6A and 6D illustrate five dealer hands (field 606) are drawn randomly from five separate virtual decks (field 610). The UI manager 216 and the dealer simulator 215 indicate to the player(s) that dealer cards have been drawn and are facing down.

At step 322, community cards may be facing up or facing down depending on the game rules. Any down-facing community cards must be revealed. Revealing of any down-facing community cards may be done after player's decision 324 to either Raise (field 616; leading to Add Bet—step 326) or Check (field 614, field 704). If the player decides to Raise, it will lead to automatically processing the remaining steps of the game in the following order: steps 328, 330/332, 322, 334, 340, 342, 344 and step 346 to end the game. If the player decides to Check, community cards may be revealed and the game will proceed to either step 324 or 334 to allow the player to make another decision.

Community cards may be used by the player only (FIG. 6E) or by both the player and dealers (FIGS. 6(A-D)) to complete hands. According to game rules, step 328 leads to either revealing player and dealer community cards (step 330) or revealing player-only community cards (step 332). Step 328 is performed automatically after player's decision to raise or to check. For example (FIG. 7B), if the player decides to check, three community cards may be revealed (field 710). There may be two community cards still facing down, which would lead the game process back to step 322, and another loop process may be performed to reveal the remaining community cards (FIG. 7C, field 720).

Once all community cards are revealed, and the player has not raised (step 334), the player has to decide in step 336 to Play/Call (leading to step 338) or Fold (FIG. 7C). When the player decides to play, additional bet value must be placed on each hand (field 724). This may be indicated in field 508. When selecting Fold (field 730) or Call (field 740), the player's balance is updated and stored in a corresponding player data structure, say 221.N. The UI manager shown in 216 is used to display the results of the bet values after the player selecting Raise (field 706).

At step 340, all dealer cards are revealed (FIG. 7D, field 750). This step is done only after the player decides to either Play (alternatively referred to as Call), Fold or Raise.

At step 342, the game results are determined (FIG. 7E, field 760). Individual results are shown to the player for each comparison of their hand versus the dealer's hands.

At step 344, the player is rewarded or the dealer collects a payment. The value rewarded or collected is determined using gameplay engine 214 which references gameplay rules 224 that follow the payout tables shown in FIGS. 11(A-C). Individual results for the player versus each dealers are added, a Total Win value may be displayed at field 762, and the player's overall Balance (field 764) may be adjusted accordingly in the corresponding player data structure 221.N.

At the end of a round of game, the player may play another round of game by selecting Repeat (field 766). A new round of game may start at step 302. When repeating a round of game, steps 310, 312 and 314 may be pre-selected for the player based on the previous round of game decisions made by the player.

At step 328, it may be possible that community cards are used only by the player to complete their hands. FIG. 6E illustrates a configuration where field 642 and field 644 provide the player with two hands to play against each dealer. Dealer hands do not use community cards in this example (field 646). With five dealers, and two hands for the player, there may be ten results per round of game. Player and community cards are withdrawn from all dealer decks, as explained above (step 318). Dealer card are randomly withdrawn from each deck as explained above (step 320).

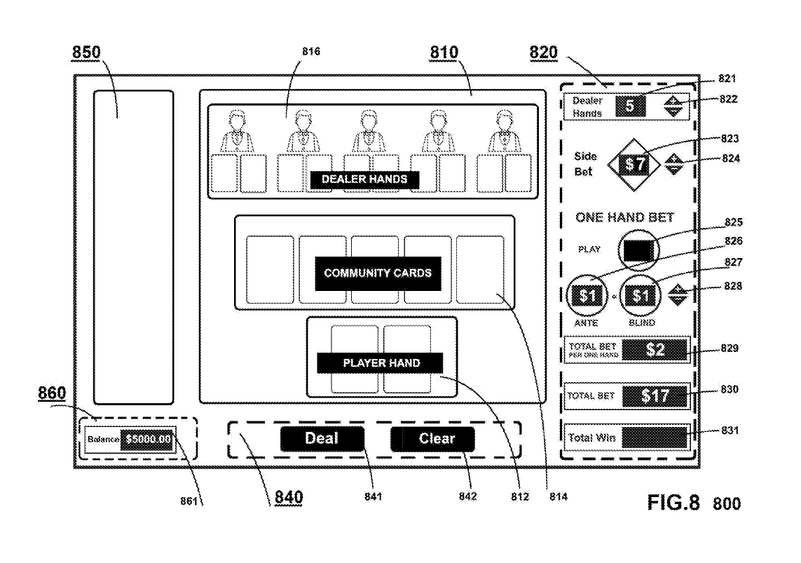

FIG. 8 illustrates an example of a UI for the system. The UI 800 may include the following regions (or areas): a table region 810, a bet management region 820, a control region 840, a notes region 850 and subscriber information region 860.

Inside table region 810, there are areas to display player's hand(s) 812, community card(s) 814 and dealer hands 816. As shown in FIG. 8, the player's hand is displayed at the bottom (region 812), five community cards are displayed in the middle (region 814), and dealer's five hands are displayed at the top (region 816). However, the positioning of the hands and number of cards in regions 812, 814 and 816 may be in a different configurations (e.g., side by side). Moreover, the player may be able to play together with other players against the dealer or compete with each other (as shown in FIG. 4(B) above). For example, a user may choose to play one hand against five dealer hands and also against four other players, with each player having one hand, while the dealer having multiple hands. A player may also have the option to play more than one hand against multiple dealer hands; a hybrid version of multi-hand per multi-dealer video poker.

If a player decides to play more than one hand against the dealer, community card(s) may be used in different ways depending on the game setup. For example, the game rules and setup may allow only the player to use community cards. In other game rules and setup, both the player and the dealer may use community cards to form their hands.

At the end of each round, card analysis results in hand rank labels such as Flush, Two Pairs or Four of a Kind that may be shown in various formats. The card analysis process picks the best cards for the player and dealer using their individual cards and any available community card(s). The results of the analysis may be displayed in regions 816 and 812.

The hand rank labels may be controlled by a UI manager 216 and are presented for all table hands on FIG. 7E. Table region 810 may also display dealers and virtual shoes which are corresponding to the each of the dealer's hands.

The bet management region 820 may display interactive user controls to manage betting aspects of the game. As shown in FIG. 8, the bet management region 820 may include a plurality of subcomponents. For example, the best management region 820 may include a side bet value field 823 and corresponding (+/−) controls field 824, a dealers hands selection field 821 and corresponding (+/−) controls field 822, one hand bet field may have Play bet field 825, Ante bet field 826, Blind Bet field 827 and corresponding (+/−) controls field 828. A player may enter a side bet by directly entering a bet value into field 823 or by increasing/decreasing the bet using (+/−) controls field 824. A player may enter a Ante=Blind bet by directly entering a bet value into fields 826 or 827, or by increasing/decreasing the bet value using (+/−) controls field 828. The bet value box and controls for fields 821, 826, 827 may be similar to the side bet field 823 above.

The bet management region 820 may also include a Total Bet per One hand field 829, a Total Bet field 830, and a Total Win field 831. The Total Bet (field 830) is equal to number of dealer hands multiplied (field 821) by the bet value per one hand (fields 826+827) plus an optional side bet value. If a side bet is won, it may be rewarded according to the value of the player's hand regardless of the value of the dealer's hand, according to the side bet pay table presented on FIG. 7E.

The Total Win field 831 may display the amount a player has won for a given round against all dealer's hands. The payout rules are described in more detail below with respect to FIGS. 11(A)-(C).

The bet management region 820 may also have other components not shown in FIG. 8. For example, instead of (or in addition to) the (+/−) controls, the region 820 may also include controls identifying default bet amounts (e.g., $10, $20, $50, $100, etc.). Users may tap these controls instead of manually entering in bets. Also the bet management region 820 may include a number of player's hands field and corresponding (+/−) controls.

The control region 840 may display other interactive user controls to manage game play. As shown in FIG. 8, the control region may include a Deal control 841 and a Clear control 842. The control region 840 may also include other controls (not shown in FIG. 8) such as Check, Raise 3X, Raise 4X, Raise 2X, Call, Fold, Repeat, Repeat and Deal, Information, etc.

The notes region 850 may display gameplay notes or other system notification(s) that may be appropriate to display during gameplay. For example, the notes region 850 may display Side Bet Bonus pay table, Blinds pay table, rules and odds (see FIGS. 4-7 and FIGS. 11(A-C)). There may also be controls (such as buttons) located near the Game Title to allow players to decide which Game Type and payout rules to display. The region 850 may further display the odds of winning with certain starting hands and odds of making certain hands. The region 850 may also display the number of tables the player currently has active, active players with the largest daily, weekly, or monthly winnings, advertisements, messages from other users currently on the site or from an administrator, an User Identification (ID), a game ID, a round ID, game results history, financial transaction history, technical settings (sounds on/off, game speed, card size, animation on/off, etc.), help options, or personal settings to stop the game at a desired win/lost limit.

The user information region 860 may display information regarding the user's profile. As shown in FIG. 8, the user information region 860 may display a subscriber's balance and player's name (not shown). The region 860 may also display other information, such as the number of hands a user has played during the current game session, the odds of winning for the user for a given hand, the odds of making certain hands, the user's win level, the user's largest pot won, etc.

The UI displayed in FIG. 8 is only one example of a UI that may facilitate gameplay according to an embodiment of the present invention. Other UI designs and functionalities may be implemented to facilitate the gameplay of multi-hand video poker according to embodiments of the present invention.

FIGS. 9-10 illustrate gaming devices that that may implement the various multi-hand video poker games described above with respect to FIGS. 1-8 according to an embodiment of the present invention. The gaming devices may locally host video poker games (similar to electronic table 130.1 on FIG. 1) or may connect to a server, over a network, which hosts the video poker games. The gaming device 900 of FIG. 9 may include a display 901, a coin input 902, a bill and/or coupon validator 903, a card reader 904, a credit (or balance) display unit 905, and control buttons 906.

The display 901 may be a liquid crystal display (LCD/LED) or the like. The display 901 may display the UI of a video poker game according to an embodiment of the present invention. According to some embodiments of the present invention, the LCD/LED may be a touchscreen.

The coin input 902 may allow players to insert coins, chips, or other kinds of tokens to increase their playing balance. The bill and/or coupon validator 903 may allow players to insert money (such as bills) and/or coupons to increase their playing balance. The card reader 904 which may allow players to insert either a credit card or a card provided by a casino, for example, in order to increase their playing balance. The credit (or balance) display unit 905 may be an LCD or the like. The credit display unit 905 may display the player's current balance which may be adjusted accordingly during game-play as described above with respect to FIGS. 1-8.

Control buttons 906 may allow the user to interact with the UI of the video poker game as described above with respect to FIGS. 1-8. The game controls 906 may include Deal, Clear, Check, Raise 3X, Raise 4X, Raise 2X, Call, Fold, Repeat/Rebet, Repeat/Rebet and Deal, Info, (+/−) controls etc. Optionally, the controls 906 may be implemented on a touchscreen version of the display 901 or a separate display.

FIG. 10 illustrates an embodiment of an electronic gaming table device that may implement the various multi-hand video poker games described above with respect to FIGS. 1-8 according to an embodiment of the present invention. The gaming table device may allow a multiple players to play multi-hand video poker in a casino, for example. The gaming table device may include individual video displays 1001, a community display 1002 and an interactive display to show virtual dealers or avatars.

Individual video displays 1001 may be LCDs, LEDs or the like. The video displays 1001 may each correspond to one or more player hands of video poker. Moreover the displays 1001 may display the UI of a video poker according to an embodiment of the present invention. According to some embodiments of the present invention, the LCD/LED may be a touchscreen. The video displays 1001 may also include privacy screen protectors to prevent other players from seeing cards on the video display 1001. The community display 1002 may be an LCD/LED or the like and may display various aspects of the multi-hand video poker games described above with respect to FIGS. 1-8. For example, the community display 1002 may display the dealer's hands, information about the active players, the time, advertisements, etc. The interactive display 1003 may be an LCD/LED or the like and may display a live TV game host dealer, virtual dealer avatar or several virtual dealers according game setting for the minimum and maximum number of dealers available to display.

The electronic gaming table device (FIG. 10) may allow players to play games in traditional casino table game manner by using touch technology, virtual cards, gaming accessories and controls. Each player may set up an individual number for dealer's hands (or dealers) to play against. For example, Player A may play against five dealers (e.g., the top row of the five dealer's hands) while Player B may play against seven dealers hands and Player C may play against all ten dealers available at the table.

The gaming system described above is not limited to one particular game variation shown above. There are many of Casino style Hold'em poker games that have community cards for players and dealers to form best rank card hands.

The list of multileader Hold'em poker games may include, but not limited by the follow games: Ultimate Texas Hold'em, Texas Hold'em Bonus, Casino Hold'em, Pineapple, Crazy Pineapple, Double Flop Holdem, Double Flop Holdem, Chowaha and Blind Man's Bluff.

Ultimate Texas Hold'em is a ShuffleMaster casino table game poker. Ultimate Texas Hold'em features heads-up play against the Dealer and an optional Bonus Bet. The player may make one raise at any time during the course of the hand. The earlier the raise is made the higher the raise amount may be. Unlike other poker-based games, raises made after the ante still have influence on the game outcome, even if the dealer doesn't open.

Heads Up Hold'Em is an Ultimate Texas Hold'Em variant by Galaxy Gaming, based on Texas Hold'Em. The player may raise his bet one time, and has three opportunities to do so. The earlier the player raises, the more the player can bet. The main differences between Heads Up Hold'Em and Ultimate Texas Hold'Em are in the former the player may raise only 3× his Ante bet before the flop, but the game includes bad beat bonuses for losing with a straight or higher.

Texas Hold'em Bonus is a Bally Technologies-owned table game. Texas Hold'em Bonus features head-to-head play against the dealer and an optional bonus bet. Players and the dealer each receive two cards. They combine them with five community cards to make their best five-card hand. Texas Hold'em Bonus lets players bet at several different stages of the game. If the player has a strong hand after the flop then they can make additional wagers. If the player has a weak hand after the flop then the player can check and not put up more money. This game also features an optional bet, the Bonus wager. Players win the Bonus wager if their first two cards match one of the payouts listed on the paytable. The odds are printed on a sign at the table.

Casino Hold'em is a banking game invented by Stephen Au-Yeung. It is a Texas Hold'em Poker play against the house and not the other players. Subject to the dealer qualifying, it is a straight contest between the dealer's hand and the player's hand. The player may get paid an Ante Win Bonus on his Ante bet. The player can also place an AA Bonus side bet, which is based on the poker value of his two personal cards and the first three flop cards.

Pineapple—Instead of two cards, each player is dealt three cards and immediately discards one of those three pocket cards face-down before pre-flop betting begins.

Crazy Pineapple—Instead of two cards, each player is dealt three cards. Before the turn card is dealt (after the post-flop betting), each player discards one of those three pocket cards face-down. If a player does not discard a card, his or her hand is dead after the turn is dealt.

Double Flop Holdem—Whenever community cards are dealt there are two different boards dealt. Players can use their two cards in combination with either of these two separate boards, one OR the other.

Chowaha—Players get two hole cards but there are three flops (all dealt at the same time), two turns (dealt at once), and one river. Players form combinations of boards using their hole cards and specific board lines, of which there are four. The top flop cannot be used with the bottom turn and the bottom flop can't be used with the top.

Blind Man's Bluff—When each player is dealt their two pocket cards, they do not look at them. Instead they hold them against their forehead so that every other player can see them. If you look at your cards before the showdown, your hand is ruled dead.

FIGS. 11(A)-(C) are exemplary pay-out tables for the various types of bets described above with respect to FIGS. 1-10.

FIG. 11(A) is an example of a payout table for Ultimate Texas Hold'em Poker for Trips and Blind bets according to an embodiment of the present invention. The administrator (or a user) may select which payout odds he/she desires. For example, the administrator may determine that the odds in table 1 are the most beneficial for his/her business model. If the payout odds for table 1 are used, a player may win Trips Bonus 4:1 his Straight bet if he/she has a Straight.

FIG. 11(B) is an example payout table for Casino Hold'em Poker for Ante bet and AA+side bet according to an embodiment of the present invention. The administrator (or a user) may select which payout odds he/she desires. For example, the administrator may determine that the odds in Ante pay table 2 are the most beneficial for his/her business model. If the payout odds for table 2 are used, a player may win Straight Flush 25:1 his Straight Flush bet if he/she has a Straight Flush.

FIG. 11(C) is an example payout table for Texas Hold'em Bonus bets according to an embodiment of the present invention. The administrator (or a user) may select which payout odds he/she desires. For example, the administrator may determine that the odds for A-A (Player)/A-A (Dealer) in pay column 2 are the most beneficial for his/her business model. If these payout odds are used, a player may win A-A (Player)/A-A (Dealer) 1000:1 his/her bet.

The gaming system described above is not limited to the Hold'em poker embodiments shown above. For example, the gaming system may also host less than seven or more than seven cards to select the best hands comprised of more than or less than five cards. Either only the player, or both the player and dealer may form their best hands using their individual cards and community card(s), as defined by conventional poker rules. Players may also play against other players in tournaments via multi-player network systems (described above) or on a bank of connected machines. In such embodiments, the cards dealt to the additional players may also be withdrawn from the respective virtual shoes as described above.

Moreover, some components in the embodiments described above may be combined with each other as another embodiment, or a component may be divided into several subcomponents, or any other known or available component may be added. Those skilled in the art will appreciate that these techniques may be implemented in other ways without departing from the spirit and substantive features of the invention. The present embodiments are therefore to be considered in all respects as illustrative and not restrictive.

I claim:

1. A method for playing an electronic multi-dealer video poker game comprising of:
a. virtual table having at least one player, at least one player hand per player, community card(s) and a plurality of dealer hands;
b. plurality of decks or shoes n (where n is the number of dealer hands that may be determined by player's choice before the game starts) as part of the gameplay;
c. virtual decks n that are used independently by all virtual dealers when cards are randomly withdrawn, face down for all virtual dealers;
d. primary virtual deck used by the primary virtual dealer that defines which player cards and community cards are withdrawn from all secondary decks;
e. player cards(s) face up, dealt from a primary virtual deck of cards upon player input;
community cards for use by only the player, dealt from a primary virtual deck of cards, face-up, that allow for the player to have multiple hands;
g. community cards for use by only the player, dealt from a primary virtual deck of cards, face-down, that allow for the player to have multiple hands;
h. community card(s) for use by both the player and virtual dealers, withdrawn from a primary virtual deck, face-up according to conventional poker game rules;
i. community card(s) for use by both the player and virtual dealers, withdrawn from a primary virtual deck, face-down according to conventional poker game rules;
j. cards withdrawn from all secondary virtual decks that are identical to the player cards(s) and community card(s) that have been withdrawn from the primary virtual deck;
k. revealing any face-down community cards via game stages as defined by conventional poker game rules and player input;
l. forming player hand combinations by selecting the best X number of cards (where X is the number of cards needed to form a hand) from both the player cards and community card(s) according to conventional poker game rules;
m. independently dealing random cards face down for each virtual dealer from all virtual decks (including primary and all secondary decks);
n. evaluating player hand(s) result at each play stage of revealing player and dealer community cards according to poker game rules;
o. revealing dealer cards upon player input;
p. independently forming for each dealer the best hand combination by selecting the best X number of cards from community card(s) and dealer cards according to conventional poker game rules;
q. comparing the player's best card combination(s) with each of the dealer's best card combination to determine a plurality of game results (win, lose or push) as defined by conventional poker hand ranks;
r. displaying a plurality of game results to the player as defined by conventional poker payable rules.

2. The method of claim 1 wherein community card(s) for use by only the player are randomly dealt to the player hand(s) in steps (f) to (g), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

3. The method of claim 1 wherein community card(s) for use by both the player and dealer(s) are randomly dealt in steps (h) to (i), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

4. The method of claim 1, wherein the randomly withdrawn cards for each dealer (step m) originate from virtual decks where each virtual deck is independently assigned to each dealer.

5. The method of claim 1 wherein the number of game results is determined in accordance with the following formula:
GR=D×p
Where the number of Game Results (GR) is equal to the number of Dealer hands (D) multiplied by the number of player hands (P).

6. A server for an electronic multi-dealer video poker game device comprises of a housing which includes a processor, a motherboard, and a memory device; a display device supported by the processor; a plurality of input devices supported by the housing including any type of physical item with a touch screen and/or at least one button wherein the server:
a. communicates with a client device to render a virtual table having at least one player, at least one player hand per player, community card(s) and a plurality of dealer hands;
b. deals player hand(s) from a plurality of decks or shoes n (where n is the number of dealer hands that may be determined by player's choice before the game starts) as part of the gameplay;
c. creates virtual decks n that are used independently by all virtual dealers when cards are randomly withdrawn, face down for all virtual dealers;
d. creates a primary virtual deck used by the primary virtual dealer that defines which player cards and community cards are withdrawn from all secondary decks;
e. deals player cards(s) face up from a primary virtual deck of cards upon player input;
f. deals community cards for use by only the player from a primary virtual deck of cards, face-up, that allow for the player to have multiple hands;
g. deals community cards for use by only the player from a primary virtual deck of cards, face-down, that allow for the player to have multiple hands;
h. withdraws community card(s) from a primary virtual deck, face up for use by both the player and virtual dealers according to conventional poker game rules;
i. withdraws community card(s) from a primary virtual deck, face down for use by both the player and virtual dealers, according to conventional poker game rules;
j. withdraws identical cards from all secondary virtual decks, any player cards(s) and community card(s) that have been withdrawn from the primary virtual deck;
k. reveals any face-down community cards via game stages as defined by conventional poker game rules and player input;
l. forms player hand combinations by selecting the best X number of cards (where X is the number of cards needed to form a hand) from both the player cards and community card(s) according to conventional poker game rules;
m. independently deals random cards face down for each virtual dealer from all virtual decks (including primary and all secondary decks);
n. evaluates player hand(s) result at each play stage of revealing player and dealer community cards according to poker game rules;
o. reveals dealer cards upon player input;
p. independently forms for each dealer the best hand combination by selecting the best X number of cards from community card(s) and dealer cards according to conventional poker game rules;
q. compares the player's best card combination(s) with each of the dealer's best card combination to determine a plurality of game results (win, lose or push) as defined by conventional poker hand ranks;
r. displays a plurality of game results to the player as defined by conventional poker payable rules.

7. The electronic server of claim 6 wherein community card(s) for use by only the player are randomly dealt to the player hand(s) in steps (f) to (g), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

8. The electronic server of claim 6 wherein community card(s) for use by both the player and dealer(s) are randomly dealt in steps (h) to (i), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

9. The electronic server of claim 6, wherein the randomly withdrawn cards for each dealer (step m) originate from virtual decks where each virtual deck is independently assigned to each dealer.

10. The electronic server of claim 6 wherein the number of game results is determined in accordance with the following formula:
GR=D×p
Where the number of Game Results (GR) is equal to the number of Dealer hands (D) times the number of player hands (P).

11. A client device for enabling a player to play an electronic multi-dealer video poker game, the client device comprising of:
a) input devices;
b) output devices; and
c) a microprocessor operable with input and output devices to:
i. communicate with a client device to render a virtual table having at least one player, at least one player hand per player, community card(s) and a plurality of dealer hands;
ii. deal player hand(s) from a plurality of decks or shoes n (where n is the number of dealer hands that may be determined by player's choice before the game starts) as part of the gameplay;
iii. create virtual decks n that are used independently by all virtual dealers when cards are randomly withdrawn, face down for all virtual dealers;
iv. create a primary virtual deck used by the primary virtual dealer that defines which player cards and community cards are withdrawn from all secondary decks;
v. deal player cards(s) face up from a primary virtual deck of cards upon player input;
vi. deal community cards for use by only the player from a primary virtual deck of cards, face-up, that allow for the player to have multiple hands;
vii. deal community cards for use by only the player from a primary virtual deck of cards, face-down, that allow for the player to have multiple hands;
viii. withdraw community card(s) from a primary virtual deck, face up for use by both the player and virtual dealers according to conventional poker game rules;
ix. withdraw community card(s) from a primary virtual deck, face down for use by both the player and virtual dealers, according to conventional poker game rules;
x. withdraw identical cards from all secondary virtual decks, any player cards(s) and community card(s) that have been withdrawn from the primary virtual deck;
xi. reveal any face-down community cards via game stages as defined by conventional poker game rules and player input;
xii. form player hand combinations by selecting the best X number of cards (where X is the number of cards needed to form a hand) from both the player cards and community card(s) according to conventional poker game rules;
xiii. independently deal random cards face down for each virtual dealer from all virtual decks (including primary and all secondary decks);
xiv. evaluate player hand(s) result at each play stage of revealing player and dealer community cards according to poker game rules;
xv. reveal dealer cards upon player input;
xvi. independently form for each dealer the best hand combination by selecting the best X number of cards from community card(s) and dealer cards according to conventional poker game rules;
xvii. compare the player's best card combination(s) with each of the dealer's best card combination to determine a plurality of game results (win, lose or push) as defined by conventional poker hand ranks;
xviii. display a plurality of game results to the player as defined by conventional poker payable rules.

12. The electronic client device of claim 11 wherein community card(s) for use by only the player are randomly dealt to the player hand(s) in steps (vi) to (vii), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

13. The electronic client device of claim 11 wherein community card(s) for use by both the player and dealer(s) are randomly dealt in steps (viii) to (ix), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

14. The electronic client device of claim 11, wherein the randomly withdrawn cards for each dealer (step xiii) originate from virtual decks where each virtual deck is independently assigned to each dealer.

15. The electronic client device of claim 11 wherein the number of game results is determined in accordance with the following formula:
GR=D×p
Where the number of Game Results (GR) is equal to the number of Dealer hands (D) times the number of player hands (P).

16. A system for enabling a player to play electronic multi-dealer video poker game, the system comprising of:
a) a server;
b) a client device adapted for communication with the server via a network; and
c) the server operable with the client device to:
i. render a virtual table having at least one player, at least one player hand per player, community card(s) and a plurality of dealer hands;
ii. deal player hand(s) from a plurality of decks or shoes n (where n is the number of dealer hands that may be determined by player's choice before the game starts) as part of the gameplay;
iii. create virtual decks n that are used independently by all virtual dealers when cards are randomly withdrawn, face down for all virtual dealers;
iv. create a primary virtual deck used by the primary virtual dealer that defines which player cards and community cards are withdrawn from all secondary decks;
v. deal player cards(s) ace up from a primary virtual deck of cards upon player input;
vi. deal community cards for use by only the player from a primary virtual deck of cards, face-up, that allow for the player to have multiple hands;
vii. deal community cards for use by only the player from a primary virtual deck of cards, face-down, that allow for the player to have multiple hands;
viii. withdraw community card(s) from a primary virtual deck, face up for use by both the player and virtual dealers according to conventional poker game rules;
ix. withdraw community card(s) from a primary virtual deck, face down for use by both the player and virtual dealers, according to conventional poker game rules;
x. withdraw identical cards from all secondary virtual decks, any player cards(s) and community card(s) that have been withdrawn from the primary virtual deck;
xi. reveal any face-down community cards via game stages as defined by conventional poker game rules and player input;
xii. form player hand combinations by selecting the best X number of cards (where X is the number of cards needed to form a hand) from both the player cards and community card(s) according to conventional poker game rules;
xiii. independently deal random cards face down for each virtual dealer from all virtual decks (including primary and all secondary decks);
xiv. evaluate player hand(s) result at each play stage of revealing player and dealer community cards according to poker game rules;
xv. reveal dealer cards upon player input;
xvi. independently form for each dealer the best hand combination by selecting the best X number of cards from community card(s) and dealer cards according to conventional poker game rules;
xvii. compare the player's best card combination(s) with each of the dealer's best card combination to determine a plurality of game results (win, lose or push) as defined by conventional poker hand ranks;
xviii. display a plurality of game results to the player as defined by conventional poker payable rules.

17. The system of claim 16 wherein community card(s) for use by only the player are randomly dealt to the player hand(s) in steps (vi) to (vii), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

18. The system of claim 16 wherein community card(s) for use by both the player and dealer(s) are randomly dealt in steps (viii) to (ix), where each random card, upon withdrawing from a primary deck, is at the same time withdrawn from all secondary n−1 decks (where n is 1<n<∞), wherein the plurality of every identically withdrawn card is represented by one virtual card, via an electronic processing device.

19. The system of claim 16, wherein the randomly withdrawn cards for each dealer (step xiii) originate from virtual decks where each virtual deck is independently assigned to each dealer.

20. The system of claim 16 wherein the number of game results is determined in accordance with the following formula:
GR=D×p
Where the number of Game Results (GR) is equal to the number of Dealer hands (D) times the number of player hands (P).

21. The system of claim 16, wherein the computer system comprises the Internet.
